(19) United States
(12) Patent Application Publication
(10) Pub. No.: US 2017/0290462 A1
(43) Pub. Date: Oct. 12, 2017

(54) Cooking Pot Assembly

(71) Applicant: Edward G. Minto, JR., Butler, PA (US)

(72) Inventor: Edward G. Minto, JR., Butler, PA (US)

(21) Appl. No.: 15/096,684

(22) Filed: Apr. 12, 2016

(51) Int. Cl. A47J 36/20

(52) U.S. Cl. CPC A47J 36/20

(57) ABSTRACT

A cooking pot assembly includes a pot that may contain a fluid. The pot has a bottom wall that is hingedly coupled to an outer wall. Thus, the pot may selectively drain the fluid. A strainer is coupled to the pot. The strainer may retain food items in the pot when the fluid is drained from the pot. A pair of handles is provided. Each of the handles is coupled to the pot and each of the handles may be manipulated. A trigger is coupled to the pot and the trigger may be manipulated. The trigger is in mechanical communication with the bottom wall of the pot. The trigger urges the bottom wall between the open position and the closed position when the trigger is manipulated.

### BACKGROUND OF THE DISCLOSURE

### Field of the Disclosure

The disclosure relates to cooking devices and more particularly pertains to a new cooking device for combining a pot and a strainer.

### SUMMARY OF THE DISCLOSURE

An embodiment of the disclosure meets the needs presented above by generally comprising a pot that may contain a fluid. The pot has a bottom wall that is hingedly coupled to an outer wall. Thus, the pot may selectively drain the fluid. A strainer is coupled to the pot. The strainer may retain food items in the pot when the fluid is drained from the pot. A pair of handles is provided. Each of the handles is coupled to the pot and each of the handles may be manipulated. A trigger is coupled to the pot and the trigger may be manipulated. The trigger is in mechanical communication with the bottom wall of the pot. The trigger urges the bottom wall between the open position and the closed position when the trigger is manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a cooking pot assembly according to an embodiment of the disclosure.

FIG. 2 is a right side view of an embodiment of the disclosure.

FIG. 3 is a top cut-away view of an embodiment of the disclosure.

FIG. 4 is a cross sectional view taken along line 4-4 of FIG. 3 of an embodiment of the disclosure.

FIG. 5 is a front view of an embodiment of the disclosure.

### DESCRIPTION OF THE PREFERRED EMBODIMENT

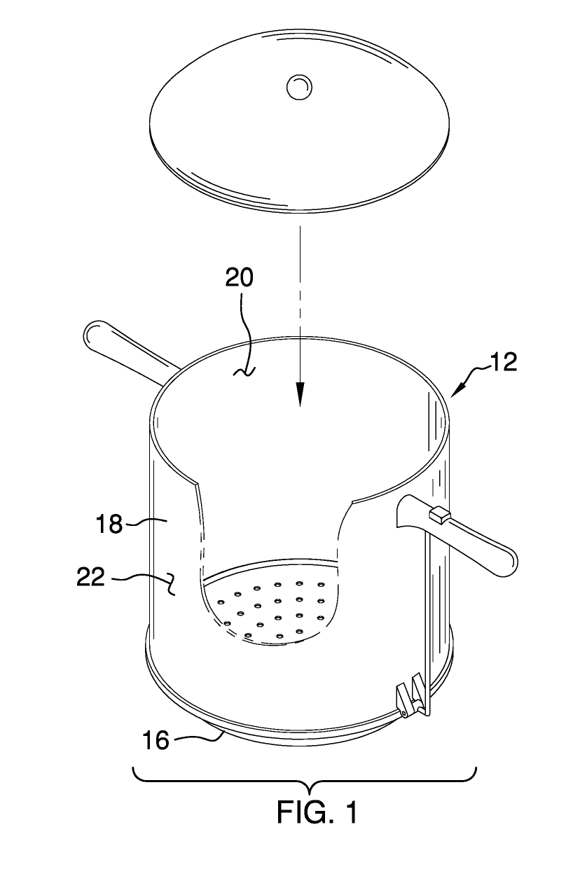

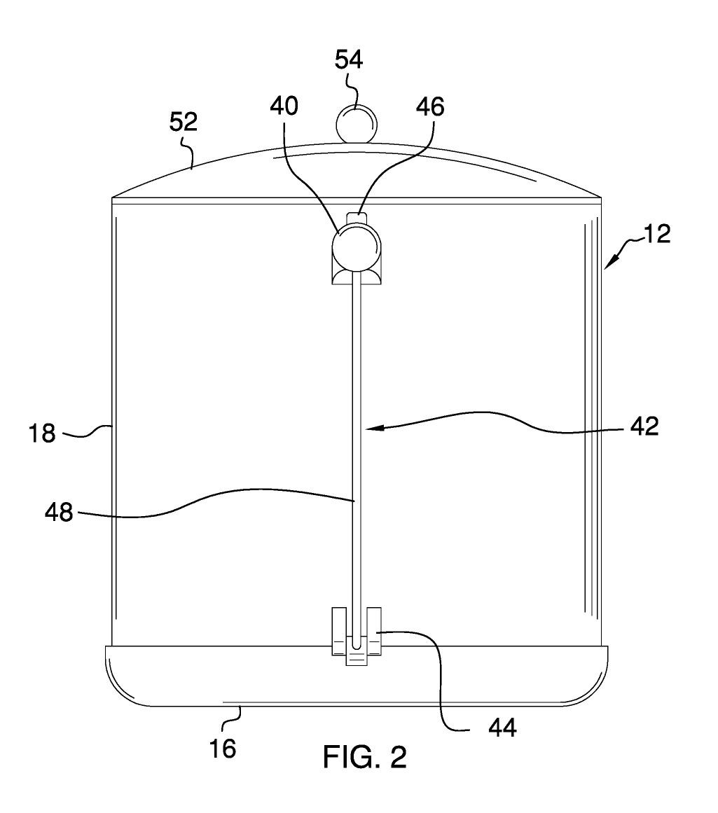

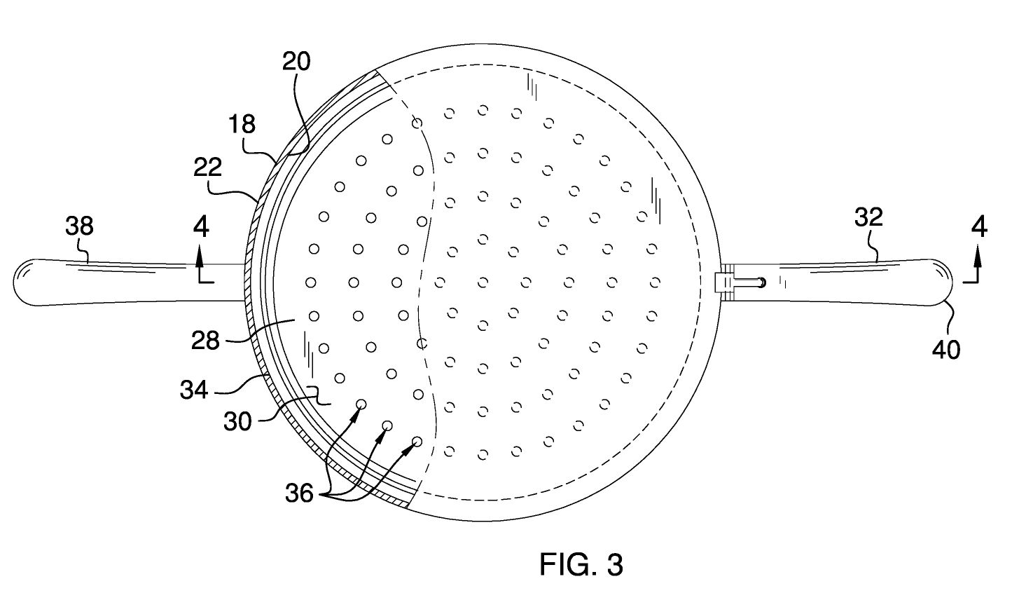

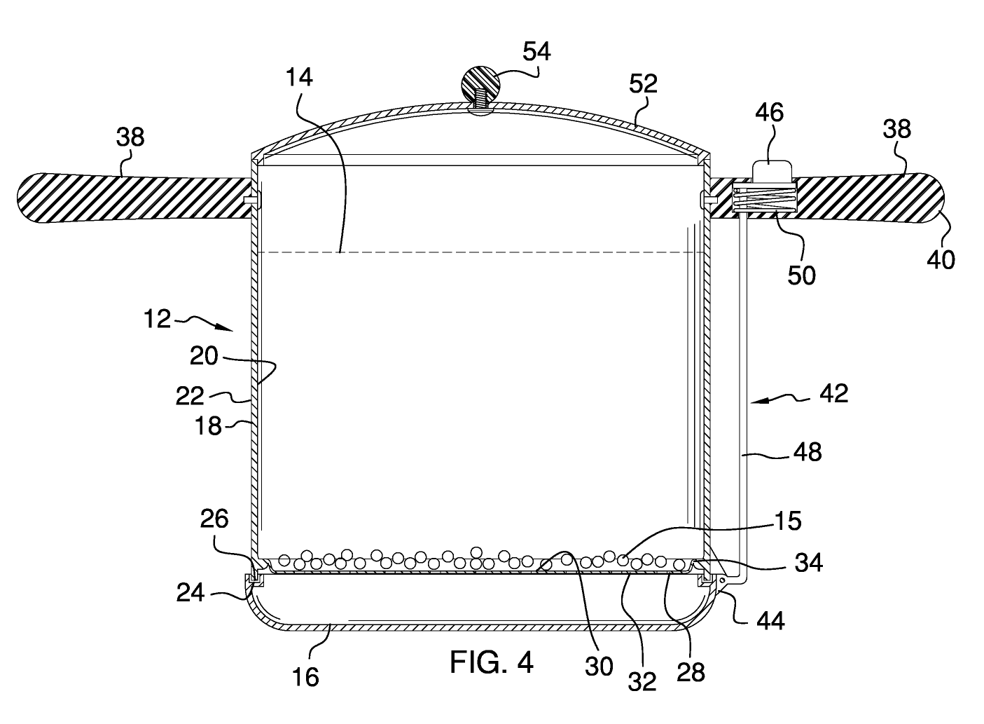

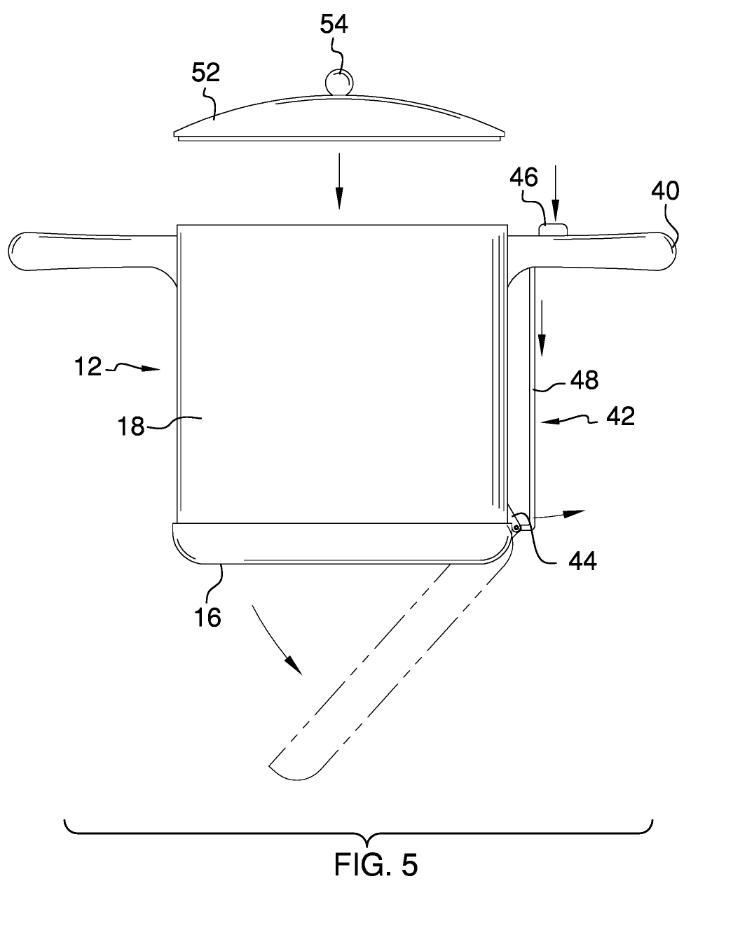

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the cooking pot assembly 10 generally comprises a pot 12 that may contain a fluid 14. The fluid 14 may be water. The pot 12 may be positioned on a stove or the like and the fluid 14 may be boiled. Thus, the fluid 14 may cook a food item 15 such as pasta or the like.

The pot 12 has a bottom wall 16 that is hingedly coupled to an outer wall 18. The bottom wall 16 is positioned between an open position to release the fluid 14 from the pot 12. The bottom wall 16 is positioned in a closed position to retain the fluid 14 in the pot 12. The outer wall 18 has an inner surface 20, an outer surface 22 and a bottom edge 24. The bottom wall 16 engages the bottom edge 24 when the bottom wall 16 is in the closed position.

A gasket 26 is coupled to the bottom wall 16. The gasket 26 is continuous such that the gasket 26 has a circular shape. The bottom edge 24 of the outer wall 18 engages the gasket 26 when the bottom wall 16 is in the closed position. Thus, the gasket 26 forms a fluid impermeable seal with the outer wall 18 thereby inhibiting the fluid 14 from escaping the pot 12. The gasket 26 may be comprised of a resiliently compressible material such as rubber or the like.

A strainer 28 is coupled to the pot 12. The strainer 28 retains the food item 15 in the pot 12 when the fluid 14 is drained from the pot 12. The strainer 28 has a top surface 30, a bottom surface 32 and a peripheral edge 34 extending therebetween. The peripheral edge 34 is continuous such that the strainer 28 forms a disk.

The strainer 28 has a plurality of openings 36 extending through the top surface 30 and the bottom surface 32. Thus, the fluid 14 may pass through the openings 36. The peripheral edge 34 is coupled to the inner surface 20 of the outer wall 18. The strainer 28 is substantially aligned with the bottom edge 24 of the outer wall 18.

A pair of handles 38 is provided. Each of the handles 38 is coupled to the pot 12 and each of the handles 38 may be manipulated. Each of the handles 38 is positioned on the outer surface 22 of the outer wall 18. The handles 38 are oppositionally positioned with respect to each other and the pair of handles 38 includes a first handle 40.

A trigger 42 is provided. The trigger 42 is coupled to the pot 12 and the trigger 42 may be manipulated. The trigger 42 is in mechanical communication with the bottom wall 16 of the pot 12. Thus, the trigger 42 urges the bottom wall 16 between the open position and the closed position when the trigger 42 is manipulated.

The trigger 42 comprises a hinge 44 that is coupled to the outer surface 22 of the pot 12. The hinge 44 is aligned with the bottom edge 24 of the pot 12. The bottom wall 16 engages the hinge 44. The hinge 44 may comprise a slow opening hinge or the like. A button 46 is movably positioned on the first handle 40 and the button 46 may be manipulated. The button 46 is positioned in a depressed position and a released position.

A rod 48 is coupled between the button 46 and the hinge 44. The rod 48 urges the bottom wall 16 into the open position when the button 46 is in the depressed position. The rod 48 urges the bottom wall 16 into the closed position when the button 46 is in the released position. A biasing member 50 is positioned within the first handle 40. The biasing member 50 engages the button 46. Thus, the biasing member 50 biases the button 46 into the released position.

A lid 52 is provided. The lid 52 is positioned on the pot 12 to cover the pot 12. A knob 54 is coupled to the pot 12. The knob 54 may be gripped.

In use, the fluid 14 is poured into the pot 12 and the pot 12 is placed on a stove or the like to cook food item 15. The handles 38 are gripped and the pot 12 is removed from the stove when the food item 15 has finished cooking. The pot 12 is placed over a sink or the like and the button 46 is depressed. The bottom wall 16 is urged into the open position and the fluid 14 drains form the pot 12. The button 46 is released when the fluid 14 has completely drained from the pot 12 and the bottom wall 16 is urged into the closed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking pot assembly having a hinged bottom wherein said assembly is configured to selectively drain a fluid, said assembly comprising:
a pot being configured to contain a fluid, said pot having a bottom wall being hingedly coupled to an outer wall wherein said pot is configured to selectively drain the fluid;
a strainer being coupled to said pot wherein said strainer is configured to retain food items in said pot when the fluid is drained from said pot;
a pair of handles, each of said handles being coupled to said pot wherein each of said handles is configured to be manipulated; and
a trigger being coupled to said pot wherein said trigger is configured to be manipulated, said trigger being in mechanical communication with said bottom wall of said pot such that said trigger urges said bottom wall between said open position and said closed position when said trigger is manipulated.

2. The assembly according to claim 1, wherein said bottom wall is positioned between an open position wherein said bottom wall is configured to release the fluid from said pot, said bottom wall being positioned in a closed position wherein said bottom wall is configured to retain the fluid in said pot, said outer wall having an inner surface, an outer surface and a bottom edge, said bottom wall engaging said bottom edge when said bottom wall is in said closed position.

3. The assembly according to claim 2, further comprising a gasket being coupled to said bottom wall, said gasket being continuous such that said gasket has a circular shape, said bottom edge of said outer wall engaging said gasket when said bottom wall is in said closed position wherein said gasket is configured to form a fluid impermeable seal with said outer wall thereby inhibiting the fluid from escaping said pot.

4. The assembly according to claim 1, wherein:
said outer wall has an inner surface and a bottom edge; and
said strainer has a top surface, a bottom surface and a peripheral edge extending therebetween, said peripheral edge being continuous such that said strainer forms a disk, said strainer having a plurality of openings extending through said top surface and said bottom surface wherein said openings are configured to have the fluid pass therethrough, said peripheral edge being coupled to said inner surface of said outer wall, said strainer being substantially aligned with said bottom edge of said outer wall.

5. The assembly according to claim 1, wherein each of said handles is positioned on said outer surface of said outer wall, said handles being oppositionally positioned with respect to each other, said pair of handles including a first handle.

6. The assembly according to claim 1, wherein:
said pot has an outer surface and a bottom edge; and
said trigger comprises a hinge being coupled to said outer surface of said pot, said hinge being aligned with said bottom edge of said pot, said bottom wall engaging said hinge.

7. The assembly according to claim 1, further comprising a button being movably positioned on a first handle wherein said button is configured to be manipulated, said button being positioned in a depressed position and a released position.

8. The assembly according to claim 7, wherein:
said trigger includes a hinge, said bottom wall engaging said hinge; and
a rod being coupled between said button and said hinge, said rod urging said bottom wall into said open position when said button is in said depressed position, said rod urging said bottom wall into said closed position when said button is in said released position.

9. The assembly according to claim 7, further comprising a biasing member being positioned within said first handle, said biasing member engaging said button, said biasing member biasing said button into said released position.

10. A cooking pot assembly having a hinged bottom wherein said assembly is configured to selectively drain a fluid, said assembly comprising:
a pot being configured to contain a fluid, said pot having a bottom wall being hingedly coupled to an outer wall, said bottom wall being positioned between an open position wherein said bottom wall is configured to release the fluid from said pot, said bottom wall being positioned in a closed position wherein said bottom wall is configured to retain the fluid in said pot, said outer wall having an inner surface, an outer surface and a bottom edge, said bottom wall engaging said bottom edge when said bottom wall is in said closed position;
a gasket being coupled to said bottom wall, said gasket being continuous such that said gasket has a circular shape, said bottom edge of said outer wall engaging said gasket when said bottom wall is in said closed position wherein said gasket is configured to form a fluid impermeable seal with said outer wall thereby inhibiting the fluid from escaping said pot;
a strainer being coupled to said pot wherein said strainer is configured to retain food items in said pot when the fluid is drained from said pot, said strainer having a top surface, a bottom surface and a peripheral edge extending therebetween, said peripheral edge being continuous such that said strainer forms a disk, said strainer having a plurality of openings extending through said top surface and said bottom surface wherein said openings are configured to have the fluid pass therethrough, said peripheral edge being coupled to said inner surface of said outer wall, said strainer being substantially aligned with said bottom edge of said outer wall;
a pair of handles, each of said handles being coupled to said pot wherein each of said handles is configured to be manipulated, each of said handles being positioned on said outer surface of said outer wall, said handles being oppositionally positioned with respect to each other, said pair of handles including a first handle; and
a trigger being coupled to said pot wherein said trigger is configured to be manipulated, said trigger being in mechanical communication with said bottom wall of said pot such that said trigger urges said bottom wall between said open position and said closed position when said trigger is manipulated, said trigger comprising:
a hinge being coupled to said outer surface of said pot, said hinge being aligned with said bottom edge of said pot, said bottom wall engaging said hinge,
a button being movably positioned on said first handle wherein said button is configured to be manipulated, said button being positioned in a depressed position and a released position,
a rod being coupled between said button and said hinge, said rod urging said bottom wall into said open position when said button is in said depressed position, said rod urging said bottom wall into said closed position when said button is in said released position, and
a biasing member being positioned within said first handle, said biasing member engaging said button, said biasing member biasing said button into said released position.
